(19) United States
(12) Patent Application Publication
(10) Pub. No.: US 2008/0062356 A1
(43) Pub. Date: Mar. 13, 2008

(54) POLARIZING PLATE, LIQUID CRYSTAL DEVICE, AND ELECTRONIC APPARATUS

(75) Inventor: Masafumi SAKAGUCHI, Suwa-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/851,451

(22) Filed: Sep. 7, 2007

(30) Foreign Application Priority Data
Sep. 7, 2006 (JP) 2006-242426

(51) Int. Cl. G02F 1/1335; G02B 27/28

(52) U.S. Cl. 349/96; 359/485

(57) ABSTRACT

A polarizing plate includes a polarizing film having a transmission axis and a first protection layer having a predetermined first optical axis formed by stretching the first protection layer. The first protection layer is disposed on one side of the polarizing film such that the first optical axis is aligned with the transmission axis of the polarizing film.

### CROSS-REFERENCE TO RELATED APPLICATION

This application claims priority from Japanese Patent Application No. 2006-242426, filed in the Japanese Patent Office on Sep. 7, 2006, the entire disclosure of which is hereby incorporated by reference in its entirety.

### BACKGROUND

1. Technical Field

Exemplary embodiments of the invention include a polarizing plate used, for example, in a liquid crystal device using liquid crystals driven to be vertically aligned, a liquid crystal device having the polarizing plate, and an electronic apparatus such as a liquid crystal projector or a direct-view-type display.

2. Related Art

In this type of liquid crystal device, for example, polarizing films, made of PVA (polyvinyl alcohol) or the like that define polarization of light, polarizing elements having protection layers which are made of TAC (triacetyl cellulose) and disposed on both sides of the polarizing films, and polarizing plates having support substrates that support the polarizing films and the polarizing elements are disposed on both sides of the liquid crystal panel. Of light incident to the polarizing plate, a polarizing plate disposed on the light incident side transmits straight polarized light having a component of amplitude parallel to a transmission axis of the polarizing film and emits the straight polarized light to the liquid crystal panel. Of light emitted from the liquid crystal panel, a polarizing plate disposed on the light emitting side selectively emits straight polarized light having a predetermined direction of amplitude to a display area of the liquid crystal device.

A mismatch occurs between the transmission axis of the polarizing film and an optical axis of the protection layer. In particular, in the polarizing plate having a protection layer such as TAC, since there are a plurality of optical axes of TAC within a face of the TAC and directions of the optical axes of the TAC are random, it is difficult to match the transmission axis of the polarizing film and optical axes of the protection layer to each other. Thus, generally, the effect of the optical axes of the protection layer on decrease in contrast of the liquid crystal device is suppressed commonly by forming the protection layer such as the TAC layer so as to lower a retardation value of the protection layer (for example, see Japanese Patent No. 3327410).

However, since the TAC layer is formed to be thin, there is a problem that tolerance of the TAC used as a protection layer to external factors is small. In particular, the protection layer may be distorted due to external factors such as heat or a mechanical stress, whereby a plurality of optical axes are formed along different directions within the protection layer due to the distortion. Thus, the plurality of optical axes lower a contrast level of a liquid crystal device having the polarizing plate.

In particular, for example, when transmittance of the liquid crystal device is measured in a cross-Nicole arrangement in which polarizing plates are arranged such that transmission axes thereof are orthogonal to each other, a theoretical transmittance is 0% in a case where the transmission axis of the polarizing film and optical axes of the protection layer including a slow axis or a fast axis are matched to each other. However, when there is slight mismatch between the transmission axis of the polarizing film and the optical axes of the protection layer, the transmittance increases. In other words, when the optical axes having various angles are formed due to the distortion of the TAC used as a protection layer, the transmittance of the polarizing plate in a cross-Nicole arrangement increases. Thus, when this polarizing plate is combined with a liquid crystal device, the transmittance of the liquid crystal device in a black display status increases, whereby a contrast level thereof decreases. Since the decrease in the contrast level is caused by distortion the protection layer, the decrease in the contrast level of the liquid crystal device occurs markedly as the film of the protection layer such as the TAC is thin. Moreover, the decrease in the contrast level occurs markedly in a vertical alignment display mode (VA mode) in which an image is displayed in a normally-black mode.

### SUMMERY

Some embodiments include a polarizing plate having a protection layer that has minimum-level influence on light, for example, polarized by a polarizing film, a liquid crystal device, which includes the polarizing plate, capable of displaying high-quality images with a high contrast level, and an electronic apparatus such as a liquid crystal projector having the liquid crystal device.

According to a first aspect, there is provided a polarizing plate, which is used in a liquid crystal device, including: a polarizing film; and a first protection layer having a predetermined first optical axis formed by stretching the first protection layer. The first protection layer is disposed on one side of the polarizing film such that the first optical axis is aligned with a transmission axis of the polarizing film.

The polarizing plate, for example, is disposed on at least one side between light incident and emitting sides and defines an amplitude direction of light incident to the polarizing plate or light modulated by a liquid crystal panel. The first protection layer has the first optical axis formed by stretching the first protection layer and is disposed on one side of the polarizing film such that the first optical axis is aligned with the transmission axis of the polarizing film. The polarizing film and the first protection layer, for example, are bonded to each other with an adhesive agent such as an adhesive material of which retardation value is substantially negligible.

When the first protection layer of the polarizing plate, for example, is disposed on a light emitting side of the liquid crystal panel such that the first protection layer opposes the liquid crystal panel, since the first protection layer does not have a plurality of axes, modulated light emitted from the liquid crystal panel is incident to the first polarizing film without being influenced by birefringence due to mismatch between the axis of the first protection layer and the transmission axis of the polarizing film, whereby only a component having amplitude aligned with the transmission axis of the polarizing film is emitted. Accordingly, the modulated light can transmit through the polarizing plate without disturbing the phase of the modulated light modulated by the liquid crystal panel.

On the other hand, when the first protection layer of the polarizing plate, for example, is disposed on a light incident side of the liquid crystal panel such that the first protection layer opposes the liquid crystal panel, since the first protection layer does not have a plurality of axes, light polarized by the polarizing film is incident to the liquid crystal panel without being influenced by birefringence due to mismatch between the axis of the first protection layer and the transmission axis of the polarizing film. Thus, polarization of light performed by the liquid crystal layer is designed on the basis of straight polarized light. When the polarizing plate is used, since light prior to a stage for performing light modulation, for example, by using a VA mode liquid crystal layer or the phase of light modulated by the liquid crystal layer is not disturbed by the first protection layer, it is possible to increase the contrast level of the liquid crystal device.

The polarizing plate may further include a second protection layer having a second optical axis and disposed on the other side of the polarizing film such that the second optical axis is aligned with the transmission axis of the polarizing film.

In such a case, only light having amplitude aligned with the transmission axis of the polarizing film can be emitted through the polarizing plate without disturbing light incident to the polarizing film or the phase of light polarized by the polarizing film.

The polarizing plate may further include a support substrate having a predetermined third optical axis and bonded to a side of the second protection layer opposite the polarizing film side of the second protection film such that the third optical axis is aligned with the first and second optical axes.

In such a case, the support substrate can support the polarizing film by interposing the second protection layer therebetween. Thus, an external stress applied to the polarizing film can be decreased, whereby deformation of the polarizing film plate can be prevented. In addition, it is possible to reduce deterioration of the polarizing film.

The support substrate may be made of sapphire or crystal.

In such a case, since yellowing of TAC caused by a chemical reaction that is influenced by change of environments such as temperature or humidity can be prevented, change of the transmittance or color of the polarizing plate over a long period can be prevented.

The first and second protection layers may sandwich the polarizing film therebetween and be bonded to each other by interposing therebetween a sealing member in the shape of a frame.

In such a case, since the polarizing film can be shielded from an external air, deformation of the polarizing film caused by change of environments such as temperature or humidity can be prevented.

According to a second aspect there is provided a liquid crystal device including: a liquid crystal layer; an incident side polarizing plate disposed on a light incident side of the liquid crystal layer; and an emitting side polarizing plate disposed on a light emitting side of the liquid crystal layer. The emitting side polarizing plate has a first polarizing film and a first protection layer including a predetermined first optical axis formed by stretching the first protection layer, and the first protection layer is disposed on a liquid crystal layer side relative to the first polarizing film such that the first optical axis is aligned with a transmission axis of the first polarizing film.

An embodiment of a liquid crystal device includes a first polarizing film that is an organic film such as PVA and that has a form in the shape of a film. The first polarizing film emits light incident to the first polarizing film as straight polarized light.

The first protect ion layer has a predetermined first optical axis formed by being stretched, and the first protection layer is disposed on a liquid crystal layer side relative to the first polarizing film such that the first optical axis is aligned with die transmission axis of the first polarizing film. The polarizing film and the first protection layer, for example, are bonded to each other with an adhesive agent such as an adhesive material of which retardation value is substantially negligible.

Since the emitting side polarizing plate is disposed on the light emitting side relative to the liquid crystal layer and the first protection layer is disposed on the liquid crystal layer side relative to the first polarizing film, light modulated by the liquid crystal layers is emitted from the first polarizing film as straight polarized light. In the polarizing plate, an amplitude component other than that of light, for example, modulated by a VA mode liquid crystal layer does not exist and the function of the polarizing film is not deteriorated. Thus, since a black color is displayed at a relatively low grayscale level in the liquid crystal device, it is possible to relatively increase the contrast level of the liquid crystal device.

The emitting side polarizing plate may further include a second protection layer disposed on a side of the first polarizing film opposite the liquid crystal layer, and the second protection layer may include a predetermined second optical axis and be disposed such that the second optical axis is aligned with the transmission axis of the first polarizing film.

In such a case, only light having amplitude aligned with the transmission axis of the first polarizing film can be emitted through the emitting side polarizing plate without disturbing the phase of light incident to the first polarizing film.

The liquid crystal device may further include a first support substrate having a predetermined third optical axis and bonded to a side of the second protection layer opposite the first polarizing film side such that the third optical axis is aligned with the first and second optical axes.

In such a case, since birefringence does not occur in the first support substrate and a polarized component emitted from the first polarizing film is not absorbed by the first support substrate, there is no heat radiation due to absorption of an amplitude component other than the straight polarized light in displaying black, and accordingly, it is possible to prevent deformation of the polarizing plate due to heat.

The first support substrate may be made of sapphire or crystal.

In such a case, application of an external stress such as heat expansion or contraction to the first polarizing film can be reduced, whereby deformation of the emitting side polarizing plate can be prevented. In addition, change in quality of the first polarizing film by time can be prevented.

The incident side polarizing plate may include a second polarizing film and a third protection layer having a predetermined fourth optical axis formed by stretching the third protection layer, and the third protection layer may be disposed on a liquid crystal side relative to the second polarizing film such that the fourth optical axis is aligned with the transmission axis of the second polarizing film.

In such a case, the phase of light polarized by the second polarizing film is not disturbed by the third protection layer and it is possible to enter only light having amplitude aligned with the transmission axis of the second polarizing film to the liquid crystal layer.

The incident side polarizing plate may further include a fourth protection layer disposed on a side of the second polarizing film opposite the liquid crystal layer, and the fourth protection layer may have a fifth optical axis and be disposed such that the fifth optical axis is aligned with the transmission axis of the second polarizing film.

In such a case, the phase of light is not disturbed in a case where polarized light, for example, viewed in the liquid crystal projector is emitted from a polarization converting element, and thus, effective transmission can be made, whereby a light use efficiency can be improved. Furthermore, since a component of elliptical polarization is not incident to the second polarizing film, deterioration or degeneration of the second polarizing film can be prevented.

The liquid crystal device may further include a second support substrate having a sixth optical axis and bonded to a side of the fourth protection layer opposite the second polarizing film side such that the sixth optical axis is aligned with the transmission axis, the fourth optical axis, and the fifth optical axis.

In such a case, change in quality of the second polarizing film by time can be prevented.

The second support substrate may be made of sapphire or crystal.

In such a case, application of an external stress such as heat expansion or contraction to the second polarizing film can be reduced, whereby deformation of the incident side polarizing plate can be prevented.

The crystal layer may have liquid crystal molecules having negative dielectric anisotropy, and the incident side and emitting side polarizing plates may be disposed to have transmission axes thereof orthogonal to each other.

In such a case, since the liquid crystal molecules are driven in a vertical alignment (VA) mode and the transmission axes of the incident side and emitting side polarizing films are orthogonal to each other, that is, the incident side and emitting side polarizing films are disposed to be in a cross-Nicole arrangement, an image is displayed in a normally-black mode. Furthermore, an image having a high contrast level can be displayed even for a liquid crystal device having negative dielectric anisotropy for which an effect of a retardation value on the contrast level is large.

According to a third aspect, there is provided an electronic apparatus having the above-described liquid crystal device.

Since the electronic apparatus has the above-described liquid crystal device, various electronic apparatuses such as a projection-type display device, a cellular phone, an electronic diary, a word processor, a viewfinder-type or monitor direct view-type video cassette recorder, a workstation, a video phone, a POS terminal, a touch panel, and the like capable of displaying high-quality images can be implemented.

The above described aspects will be disclosed in the following exemplary embodiments.

### BRIEF DESCRIPTION OF THE DRAWINGS

Exemplary embodiments of the invention will be described with reference to the accompanying drawings, wherein like numbers reference like elements.

FIG. 1 is a schematic broken sectional view obtained by breaking out a part of a polarizing plate according to an exemplary embodiment of the invention.

FIG. 2 is a schematic perspective view showing directions of optical axes of protection layers and a transmission axis of a polarizing film according to an exemplary embodiment of the invention.

FIGS. 3A and 3B are schematic plan views showing a modified example of a polarizing plate according to an exemplary embodiment of the invention.

FIG. 4 is a plan view of a liquid crystal device according to an exemplary embodiment of the invention including constituent elements, relative to an opposing substrate side.

FIG. 5 is a sectional view of FIG. 4 taken along line V-V′.

FIG. 6 is a schematic diagram showing a structure of a liquid crystal device according to an exemplary embodiment of the invention in which relationship of relative directions among optical axes of protection layers included in the polarizing plates and the transmission axis of the polarizing film are represented.

FIG. 7 is a sectional view showing a structure of a liquid crystal projector as an electronic apparatus according to an exemplary embodiment of the invention.

FIG. 8 is a perspective view showing a structure of a direct view-type display device as an electronic apparatus according to another exemplary embodiment of the invention.

FIG. 9 is a perspective view showing a structure of a cellular phone as an electronic apparatus according to another exemplary embodiment of the invention.

FIG. 10 is a perspective view showing a structure of a light valve as an electronic apparatus according to another exemplary embodiment of the invention.

### DESCRIPTION OF EXEMPLARY EMBODIMENTS

Hereinafter, a polarizing plate, a liquid crystal device, and an electronic apparatus according to exemplary embodiments of the present invention will be described with reference to the accompanying drawings.

### 1. Polarizing Plate

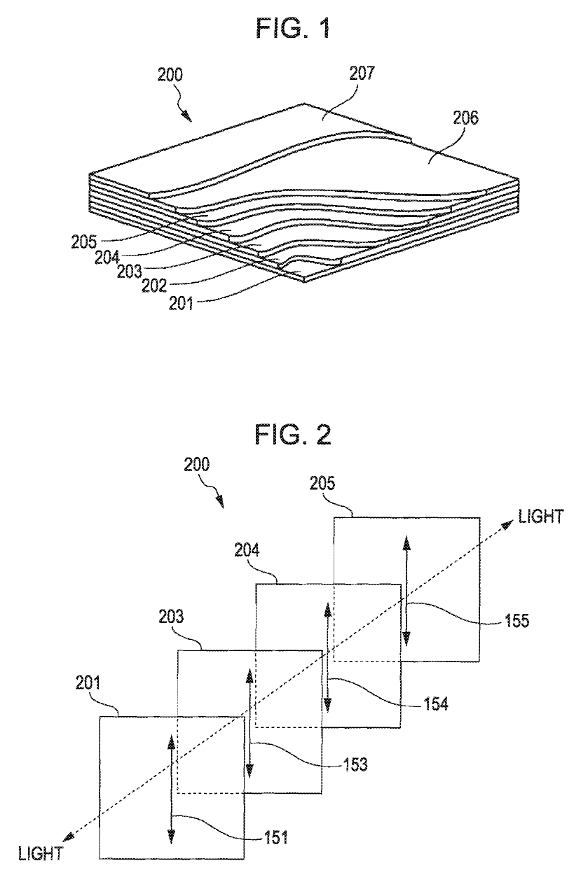

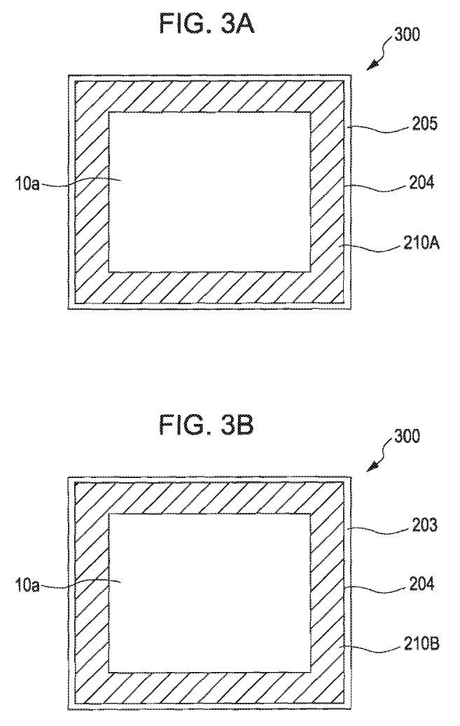

First, a polarizing plate according to an exemplary embodiment of the invention will be described with reference to FIGS. 1 to 3. FIG. 1 is a schematic cut-away sectional view obtained by cutting away parts of a polarizing plate according to the embodiment. FIG. 2 is a schematic perspective view showing directions of optical axes of protection layers and a transmission axis of a polarizing film according to an exemplary embodiment of the invention. FIGS. 3A and 3B are schematic plan views showing a modified example of a polarizing plate according to the embodiment. The polarizing plate 200 according to the embodiment, for example, is used in a liquid crystal device such as a light valve of a liquid crystal projector. The polarizing plate 200 is disposed on at least one side between a light emitting side, from which emitting light exits, relative to a liquid crystal layer and a light incident side, at which incident light enters, relative to the liquid crystal layer, wherein the liquid crystal layer is driven to be vertically aligned with being vertically aligned as an initial alignment status and includes liquid crystal molecules having negative dielectric anisotropy.

As shown in FIGS. 1 and 2, before being disposed in a liquid crystal device, the polarizing plate 200 includes a support substrate 201, an adhesion layer 202, a second protection layer 203, a polarizing film 204, a first protection layer 205, a coating layer 206, and a protection film 207.

The support substrate 201 is made of sapphire or crystal. The support substrate 201 prevents application of an external stress to the polarizing film 204 ands as described later, does not disturb light to be polarized by the polarizing film 204 or light polarized by the polarizing films 204.

The polarizing film 204 is an organic film such as one formed of PVA and is formed in the shape of a film. The polarizing film 204 emits light, which has been incident to the polarizing film 2045 as straight polarized light. The second protection layer 203, for example, is made of an optical material such as a transparent film including TAC having a second optical axis 153 formed by being stretched in a predetermined direction, and a second optical axis 153 is disposed to be aligned with a transmission axis of the polarizing film 204.

The first protection layer 205 has only a first optical axis 155 that is formed by being stretched in a predetermined direction. The first protection layer 205 is bonded to one face of the polarizing film 204 such that the first optical axis 155 is aligned with a transmission axis 154 of the polarizing film 204. The polarizing film 204 and the first protection layer 205, for example, are bonded to each other with an adhesive agent (not shown) such as an adhesive material whose retardation value is substantially negligible.

When the polarizing plate 200 is disposed on a light emitting side, flow which light modulated by the liquid crystal layer is emitted, relative to the liquid crystal layer, the first protection layer 205 is located on the liquid crystal layer side relative to the polarizing filmy 204.

In this case, since the first optical axis 155 is aligned with the transmission axis 154 of the polarizing film 204, modulated light incident to the first protection layer 205 directly transmits through the first protection layer 205 without being modulated by the first protection layer 205. Thus, since there is no unintended light absorption in the polarizing film 204, to be more specific, light having an amplitude component other than that of the light modulated by the liquid crystal layer is not absorbed by the polarizing film 204, luminance of the liquid crystal device does not decrease unnecessarily. Furthermore, deterioration of quality of the polarizing film 204 can be reduced, whereby durability of the polarizing plate 200 can be improved.

When the polarizing plate 200, for example, is disposed on the light incident side of the liquid crystal layer and the first protection layer 205 is disposed on the liquid crystal layer side relative to the polarizing film 204, light polarized by the polarizing film 204 is incident to the first protection layer 205. Since the first optical axis 155 is aligned with the transmission axis 154 of the polarizing film 204, a phase of the light polarized by the polarizing film 204 is not disturbed in the first protection layer 205. In other words, the straight polarized light emitted from the polarizing film 204 directly transmits through the first protection layer 205 to be emitted to the liquid crystal layer, and light modulation is performed for the straight polarized light polarized by the polarizing film 204 by the liquid crystal layer. Especially when the polarizing plate 200 is used in a liquid crystal panel having a liquid crystal layer including liquid crystals driven in a VA mode, a phase of light is not disturbed in a stage prior to a light modulation operation that is performed on the basis of birefringence of liquid crystal molecules. Accordingly, there is no medium, which causes a phase difference, interposed between the polarizing film and the liquid crystal layer, thereby, for example, there is no case where the transmittance for a black color changes when black is displayed, and thus, it is possible to increase the contrast level of a display image.

The second protection layer 203 has a second optical axis 153 only. Furthermore, the second protection layer 203 is bonded to the other side of the polarizing film 204 such that the second optical axis 153 is aligned with the transmission axis 154 of the polarizing film 204. Accordingly, the second protection layer does not have an effect on light polarization due to the polarizing film 204 and can support the polarizing film 204. In addition, since the optical axis 151 of the support substrate 201 is aligned with the second optical axis 153, the support substrate 201 does not have an effect on the light polarization due to the polarizing film 204 like the second protection layer 203.

As described above, by using the polarizing plate 200, it is possible to prevent deterioration of the polarizing plate 200 and improve display quality of an image displayed by a liquid crystal device having the polarizing plate 200, to be more specific, a contrast level of the image.

### MODIFIED EXAMPLE

Hereinafter, modified examples of a polarizing plate according to an exemplary embodiment of the invention will be described with reference to FIGS. 3A and 3B. FIG. 3A is a plan view of a polarizing plaice 300 according to a modified example, viewed from a first protection layer 205 side. FIG. 3B is a plan view of a polarizing plate 300 according to another modified example, viewed from a second protection layer 203 side. Hereinafter, same reference numerals are assigned to parts which are common to the polarizing plates 200 and 300, and a detailed description thereof is omitted.

As shown in FIG. 3A, the first protection layer 205 included in the polarizing plate 300 is bonded to the polarizing film 204 with a sealing portion 210A in the shape of a frame which is formed along sides defining edges of the first protection layer 205 in an outer region of a display area 10a. Here, the display area means an area that is overlapped with an image display area formed by arrangement of pixels of the liquid crystal device when the polarizing plate 300 is built in the liquid crystal device.

In the polarizing plate 300, since a portion corresponding to the display area of the polarizing film 204 does not come into a direct contact with a sealing member that is an adhesive layer, stress is not applied to the display area of the polarizing film 204, whereby deformation of the polarizing film 204 can be prevented.

As shown in FIG. 3B, a second protection layer 203 included in the polarizing plate 300 is bonded to a first support substrate 201B with a sealing portion 210B in the shape of a frame which is formed along sides defining edges of the second protection layer 203. By using the sealing portion 210B, similarly to the sealing portion 210A, deformation occurring in the polarizing film 204 can be prevented. As described above, the sealing portion may be provided on a first protection layer 205 side relative to the polarizing film 203, or alternatively, the sealing portion may be provided on a second protection layer 203 side.

### 2. Liquid Crystal Device

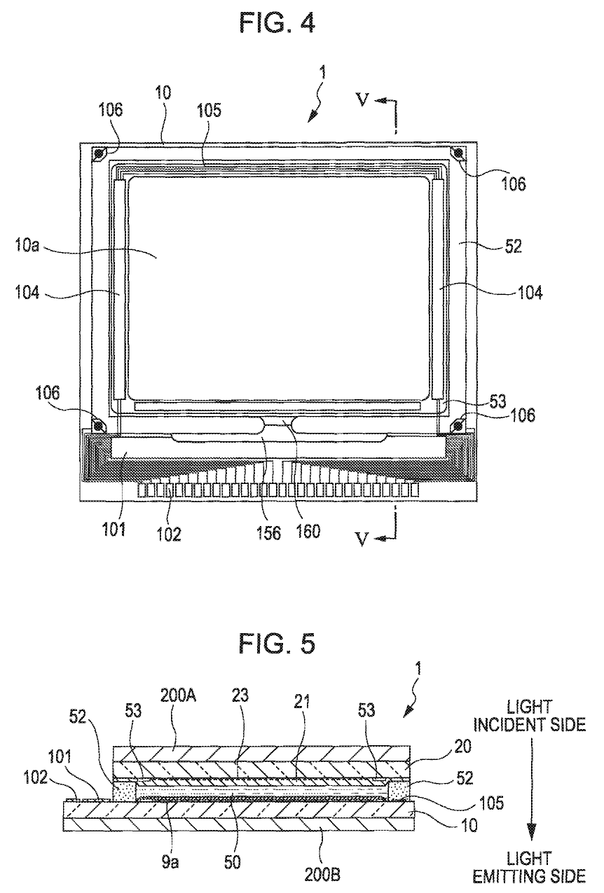

Hereinafter, a liquid crystal device according to an exemplary embodiment of the invention will be described with reference to FIGS. 4 to 6. FIG. 4 is a plan view of a liquid crystal device according to the embodiment including constituent elements, viewed from an opposing substrate side. FIG. 5 is a sectional view of FIG. 4 taken along line V-V′. In the embodiment, a driving circuit built-in liquid crystal device using a TFT active matrix driving method will be described as an example of the liquid crystal device.

The liquid crystal device 1 includes a TFT array substrate 10, an opposing substrate 20, a liquid crystal layer 50, and polarizing plates 200A and 200B.

The TFT array substrate 10, for example, is formed of a crystal substrate, a glass substrate, a silicon substrate, or the like. The opposing substrate 20, for example, is formed of a crystal substrate, a glass substrate, or the like. The TFT array substrate 10 and the opposing substrate 20 are bonded to each other with a sealing member 52 provided in a sealing area 52a around an image display area 10a that is a display area formed by arrangement of a plurality of pixels. A liquid crystal layer 50 that is driven in a VA mode is sealed between the TFT array substrate 10 and the opposing substrate 20 by the sealing member 52 and a liquid crystal sealing portion 156. In addition, a liquid crystal supply port 160 is sealed by the liquid crystal sealing portion 156 such that liquid crystal supplied through the liquid crystal supply port 160 does not leak.

As shown in FIG. 4, an opaque frame light-shielding film 53 that defines a frame area of the image display area 10a is provided on an opposing substrate 20 side and an inside of the sealing area 52a in which the sealing member 52 is disposed. In ant outer area located on an outer side of the sealing area 52a on which the sealing member 52 is disposed, a data line driving circuit 101 and an external circuit connecting terminal 102 are provided along one side of the TFT array substrate 10. A sampling circuit 7 is provided in an inner side relative to the sealing area 52a formed along one side such that the sampling circuit 7 is covered with the frame-shaped light-shielding film 53. Scan line driving circuits 104 are provided on an inner side of sealing areas formed along two sides adjacent to the one side such that the scan line driving, circuit 104s are covered with the frame light-shielding film 53. On the TFT array substrate 10, in areas facing four corner portions of the opposing substrate 20, upper and lower conduction terminals 106 for connecting the TFT array substrate 10 and the opposing substrate 20 with upper and lower conduction materials 107 are disposed. Accordingly, electrical conduction between the TFT array substrate 10 and the opposing substrate 20 can be made.

On the TFT array substrate 10, wire for electrically connecting an, external circuit connecting terminal 102 and a data line driving circuit 101, a scan line driving circuit 104, upper and lower conduction terminals 106 or the like to each other is formed.

As shown in FIG. 5, on the TFT array substrate 10, a stacked structure in which a TFT (Thin Film Transistor), which is a driving element for pixel switching, or wiring such as a scan line or a data line is formed. In the image display area 10a, a pixel electrode 9a formed of an ITO film is provided in an upper layer of the TFT for pixel switching or the wiring such as a scan line or a data line. On the pixel electrode 9a, an orientation film is formed. A light-shielding film 23 is formed on a side of the opposing substrate 20 which faces the TFT array substrate 10. On the light-shielding, film 23, an opposed electrode 21 formed of an ITO film, similar to the pixel electrode 9a, is formed to be opposed to the plurality of pixel electrodes 9a. An orientation film is formed on the opposed electrode 21. The liquid crystal layer 50 includes liquid crystal of negative dielectric anisotropy which is driven in a VA mode and is in a predetermined orientation status between a pair of orientation films. In the embodiment, incident light is incident to the liquid crystal device 1 from an opposing substrate 20 side toward a TFT array substrate side 10. In other words, the incident light is incident to the liquid crystal device 1 from the top to the bottom in the figure.

Although not shown in the figure, a test circuit, a test pattern, or the like which are used for testing the quality or detecting defects of the liquid crystal device during a manufacturing process thereof or after the manufacturing process may be formed on the TFT array substrate 10, in addition to the data driving circuit 101 and the scan line driving circuit 104.

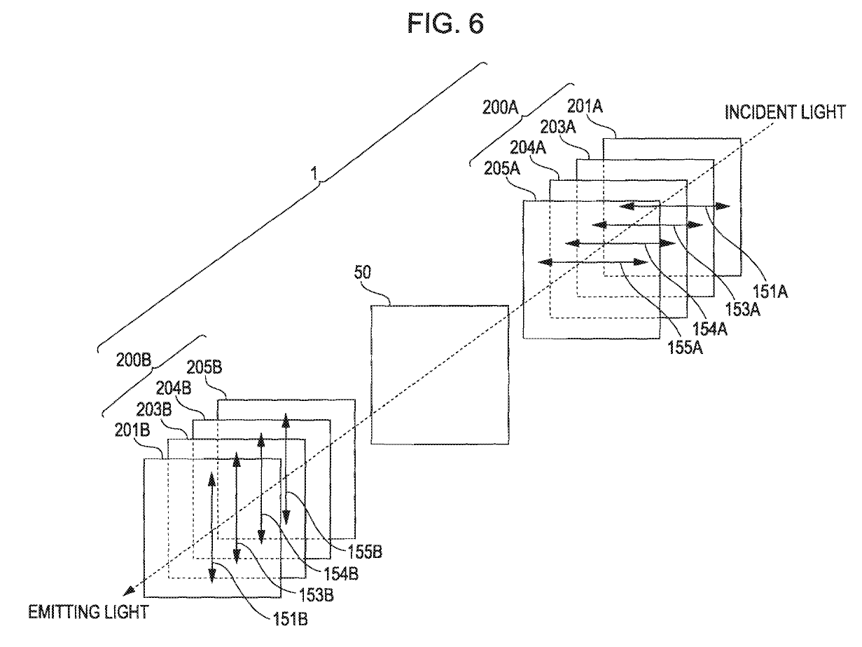

Hereinafter, relationship of relative directions among optical axes of protection layers included in the polarizing plates 200A and 200B, the transmission axis of the polarizing film, and the like will be described with reference to FIG. 6. FIG. 6 is a schematic diagram showing a structure of a liquid crystal device according to an exemplary embodiment of the invention in which relationship of relative directions among optical axes of protection layers included in the polarizing plates 200A and 200B, the transmission axis of the polarizing film, and the like are represented. The polarizing plates 200A and 200B have the same structure as the above-described polarizing plate 200. The polarizing plates 200A and 200B are examples of the incident side and emitting side polarizing plates of a liquid crystal device according to an exemplary embodiment of the invention.

As shown in FIG. 6, the liquid crystal device 1 includes polarizing plates 200A and 200B and a liquid crystal layer 50. The polarizing plate 200A has a polarizing film 204A, a third protection layer 205A, a fourth protection layer 203A, and a second support substrate 201A.

The polarizing plates 200A and 200B are disposed in a cross-Nicole arrangement, so that a transmission axis 154A of the polarizing film 204A and a transmission axis 154B of the polarizing film 204B are orthogonal to each other. The liquid crystal layer 50 is driven in a VA mode. In other words, the liquid crystal layer 50 has vertically aligned liquid crystal molecules. Accordingly, the liquid crystal device 1 displays an image in a normally-black mode in which black is displayed in the image display area 10a in a case where the liquid crystal device 1 is not driven.

The first protection layer 205B has only a first optical axis 155B that is formed by stretching the first protection layer 205B in a predetermined direction. The first protection layer 205B is disposed on one side of the polarizing film 204B facing the liquid crystal layer 50, so that the first optical axis 155B is aligned with the transmission axis 154B of the polarizing film 204B.

When the liquid crystal device 1 is operated, modulated light emitted to the first protection layer 205B from the liquid crystal layer 50 is transmitted through the first protection layer 205B without disturbing the phase thereof. Thus, the modulated light is detected as the straight polarized light. Accordingly, the transmittance in the cross-Nicole arrangement can be lowered, whereby black with a low luminance level can be acquired. Furthermore, decrease in brightness of display can be prevented. In addition, when the liquid crystal device 1 is operated, increase in temperature of the polarizing film 204B due to heat energy of superfluous light absorbed by the polarizing film 204B can be prevented, whereby the occurrence of distortion or deterioration of the polarizing film 204B due to heat of the polarizing film 204B can be prevented.

The second protection layer 203B has only a second optical axis 153B. The second protection layer 203B is disposed on a side of the polarizing film 204B opposite the liquid crystal layer 503 such that the second optical axis 153B is aligned with the transmission axis 154B of the polarizing film 204B. In addition, the first support substrate 201B is disposed on a side opposite the first protection layer 205B relative to the second protection layer 203B such that an optical axis 151B of the first support substrate 201B is aligned with the first optical axis 155B, the transmission axis 154B, and the second optical axis 153B. Accordingly, light transmitted though the polarizing film 204B is directly emitted without the phase thereof being changed.

The third protection layer 205A has only a third optical axis 155A extending in a predetermined direction. The third protection layer 205A is disposed on a liquid crystal 50 side of the polarizing film 204A such that the third optical axis 155A is aligned with the transmission axis 154A of the polarizing film 204A.

Through the third protection layer 205A, straight polarized light emitted from the polarizing film 204A is directly emitted to the liquid crystal layer 50. Thus, modulation of light performed by the liquid crystal layer 50 is designed on the basis of straight polarized light. When the polarizing plate 200A is used, for example, in a liquid crystal panel having a liquid crystal layer including liquid crystal molecules driven in a VA mode, a phase of light in a stage prior to the performance of light modulation on the basis of birefringence of the liquid crystal molecules is not disturbed and it is possible to increase the contrast level of an image displayed by the liquid crystal device 1. In other words, a phase difference of light due to a retardation value of a protection layer that is interposed between the polarizing film 204A and the liquid crystal layer 50 can be prevented, whereby the decrease in the contrast level due to the phase discrepancy can be suppressed.

The fourth protection layer 203A has only a fourth optical axis 153A. The fourth protection layer 203A is disposed on a side of the polarizing film 204A opposite the liquid crystal layer 50 such that the fourth optical axis 153A is aligned with the transmission axis 154A of the polarizing film 204A. In addition, the second support substrate 201A is disposed on a side opposite the third protection layer 205A relative to the fourth protection layer 203A such that an optical axis 151A of the second support substrate 201A is aligned with the third optical axis 155A, the transmission axis 154A, and the fourth optical axis 153A. Accordingly, light transmitted though the polarizing film 204A is directly emitted to the liquid crystal layer 50 without the phase thereof being changed.

Since a layer having a plurality of optical axes, that is, a medium generating a phase difference is not interposed between the polarizing films 204A and 204B and the liquid crystal layer 50 in the liquid crystal device 1 according to the embodiment as described above, it is possible to increase the contrast level of an image displayed by the liquid crystal device 1, for example, without changing the transmittance of a black color due to the phase difference in a case where black is displayed. In addition, since deterioration of quality of the polarizing, film due to light absorption can be prevented, it is possible to improve the durability of the liquid crystal device.

Furthermore, protection layers of the polarizing plates 200A and 200B included in the liquid crystal device 1, similarly to the above-described polarizing plate 300, may be bonded to each other by a sealing portion which is formed along sides defining edges of the polarizing film. Although the liquid crystal layer has liquid crystal molecules driven in a mode other than the VIA mode, the same advantages as in the V/A mode can be acquired.

### 3. Light Valve

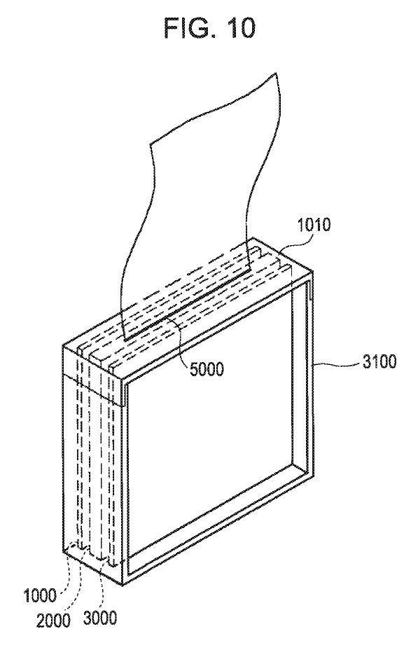

Hereinafter, a case where the above-described liquid crystal device is used in a tight valve of a projector that is an example of an electronic apparatus will be described with reference to FIG. 10. In FIG. 10, a light valve 1010 is divided into blocks by a block member 3100. The light valve 1010 has a structure in which a portion corresponding to a light valve of a projection optical system in a projector is provided separately. The light valve 1010 may be used in a multi-plate-type projector or a single-plate-type projector appropriately. A flexible print wiring substrate connected to a liquid crystal panel 2000 is drawn out form a slit 5000 formed in a position corresponding to the liquid crystal panel 2000 of the block member 3100.

Although a case where the liquid crystal panel 2000 used as an optical component and polarizing plates 1000 and 3000 are disposed with a space interposed therebetween is shown in the example of FIG. 10, a structure in which a liquid crystal panel and a polarizing plate are combined as a pair may be used. In such case, the liquid crystal panel and the polarizing plate are disposed with a space interposed therebetween. Furthermore, as a liquid crystal device according to an exemplary embodiment of the invention, a projection optical system that includes a liquid crystal panel used as a light valve and a polarizing plate disposed to be spaced apart from the liquid crystal panel along with a liquid crystal device having a polarizing plate as a light valve may be used.

### 4. Electronic Apparatus

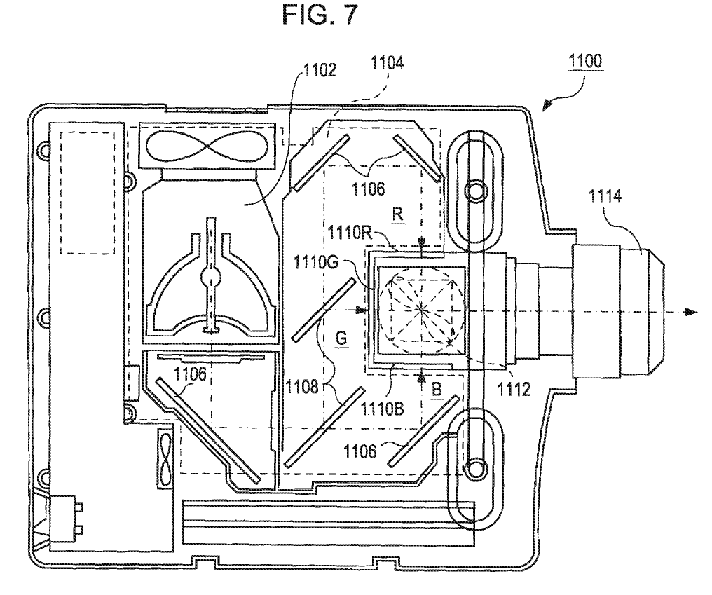

Hereinafter, a case where the above-described liquid crystal device is used in a projector that is an example of an electronic apparatus will be described with reference to FIG. 7. The above-described liquid crystal device is used as a light valve of a projector FIG. 7 is a plan view showing a structure of a projector according to an exemplary embodiment of the invention. As shown in FIG. 7, inside the projector 1100, a lamp unit 1102 including a white light source such as a halogen lamp is provided. The projection light emitted from the lamp unit 1102 is divided into primary colors of R, G, and B by four mirrors 1106 and two dichroic mirrors 1108 disposed inside a light guide 1104 and incident to the liquid crystal panels 1110R, 1110B, and 1110G as light valves.

The liquid crystal panels 1110R, 1110B, and 1110G have structures equivalent to that of the above-described liquid crystal device and are driven in accordance with signals of primary colors of R, G, and B supplied from an image signal processing circuit. The light modulated by the liquid crystal panels is incident to a dichroic prism 1112 from three directions. In the dichroic prism 1112, the light of R and B is refracted by 90 degrees and the light of G progresses straight. Accordingly, a composed image of the primary color light is projected on a screen or the like through a projection lens 1114.

Here, when display images displayed by the liquid crystal panels 1110R, 1110B, and 1110G are considered, the display image displayed by the liquid crystal panel 1110G needs to be inverted to left-to-right/right-to-left side with respect to the display images displayed by the liquid crystal panels 1110R and 1110B.

Furthermore, since light corresponding to primary colors of R, G, and B is incident to the liquid crystal panels 1110R, 1110B, and 1110G by using the dichroic mirror 1108, a color filter is not required. Since the projector 1100 includes the liquid crystal panels 1110R, 1110B, and 1110G, it is possible to display a high-quality image.

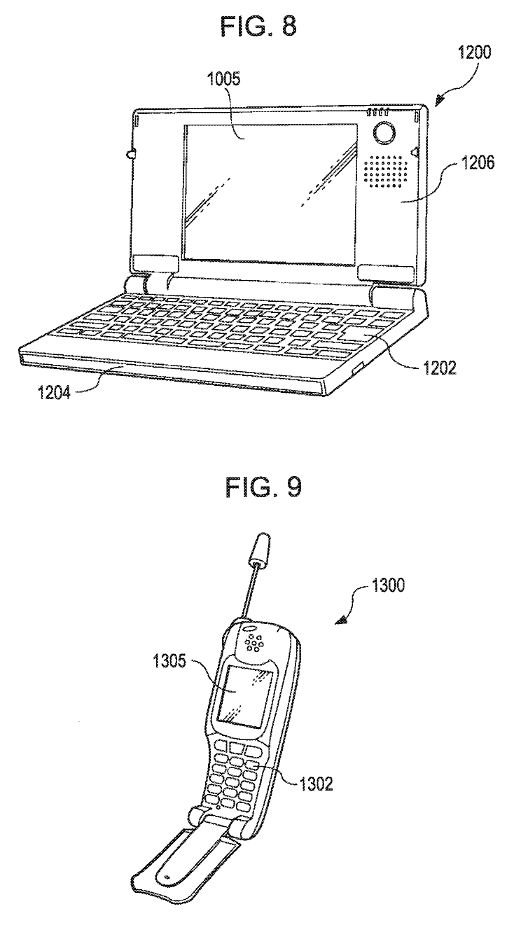

Hereinafter, a case where the above-described liquid crystal device is used in a mobile-type personal computer will be described. FIG. 8 is a perspective view showing a structure of the personal computer according to an exemplary embodiment of the invention. The personal computer 1200 includes a main frame unit 1204 having a keyboard 1202 and a liquid crystal display unit 1206 in which the above-described liquid crystal device is applied. According to the personal computer 1200, it is possible to display a high quality image on both sides of the liquid crystal unit 1206.

Hereinafter, a case where the above-described liquid crystal device is used in a cellular phone will be described. FIG. 9 is a perspective view showing a structure of the cellular phone according to an exemplary embodiment of the invention. As shown in FIG. 9, the cellular phone 1300 includes a plurality of operation buttons 1302 and a reflection-type liquid crystal device 1305 in which the above-described liquid crystal device is applied. Since front light is provided on at least one of front and rear sides of the liquid crystal device 1305, it is possible to display high quality image without an external light source.

Furthermore, a liquid crystal device according to an exemplary embodiment of the invention may be used in a television set, a viewfinder-type or monitor direct view-type video cassette recorder, a car navigator, a pager, an electronic diary, a calculator, a word processor, a workstation, a video phone, a POS terminal, an apparatus having a touch panel, or the like along with the above-described electronic apparatuses.

The present invention is not limited to the above-described exemplary embodiments, and various changes in form and details may be made appropriately therein without departing from the gist or spirit of the invention which can be conceived from the claims or the whole specification, and a polarizing plate, a liquid crystal device, and an electronic apparatus in which the changes are made belong to the technical scope of the invention.

Furthermore, in the above exemplary embodiments, a structure in which support substrates are used as protection layers and the support substrates are bonded to other support substrates may be used. Even in that case, the polarizing plate exhibits the same advantages as the above-described embodiments by providing the polarizing plate such that a protection layer having an optical axis is disposed on the liquid panel side of the polarizing plate.

What is claimed is:

1. A polarizing plate comprising:
a polarizing film having a transmission axis; and
a first protection layer having a predetermined first optical axis formed by stretching the first protection layer,
the first protection layer being disposed on one side of tire polarizing film such that the first optical axis is aligned with the transmission axis of the polarizing film.

2. The polarizing plate according to claim 1, further comprising:
a second protection layer having a second optical axis,
the polarizing film being disposed between the second protection layer and the first protection layer, and
the second optical axis being aligned with the transmission axis of the polarizing film.

3. The polarizing plate according to claim 2, further comprising:
a support substrate having a predetermined third optical axis,
the support substrate being bonded to a side of the second protection layer opposite the side of the second protection film opposing the polarizing film, and
the third optical axis being aligned with the first and second optical axes.

4. The polarizing plate according to claim 3, the support substrate being made of sapphire or crystal.

5. The polarizing plate according to claim 1, the first and second protection layers sandwiching the polarizing film therebetween, and
the first and second protection layers being bonded to each other by interposing therebetween a sealing member in the shape of a frame.

6. A liquid crystal device comprising:
a liquid crystal layer;
an incident side polarizing plate disposed on a light incident side of the liquid crystal layer; and
an emitting side polarizing plate disposed on a light emitting side of the liquid crystal layer,
the emitting side polarizing plate including a first polarizing film and a first protection layer having a predetermined first optical axis formed by stretching the first protection layer, and
the first protection layer being disposed on a liquid crystal layer side relative to the first polarizing film such that the first optical axis is aligned with a transmission axis of the first polarizing film.

7. The liquid crystal device according to claim 6,
the emitting side polarizing plate further including a second protection layer disposed on a side of the first polarizing film opposite the liquid crystal layer, and
the second protection layer including a predetermined second optical axis, the second protection layer being disposed such that the second optical axis is aligned with the transmission axis of the first polarizing film.

8. The liquid crystal device according to claim 7, further comprising:
a first support substrate having a predetermined third optical axis,
the first support substrate being bonded to a side of the second protection layer opposite the first polarizing film side such that the third optical axis is aligned with the first and second optical axes.

9. The liquid crystal device according to claim 8, the first support substrate being made of sapphire or crystal.

10. The liquid crystal device according to claim 6,
the incident side polarizing plate including (1) a second polarizing film and (2) a third protection layer having a predetermined fourth optical axis formed by stretching the third protection layer, and
the third protection layer being disposed on a liquid crystal side relative to the second polarizing film such that the fourth optical axis is aligned with the transmission axis of the second polarizing film.

11. The liquid crystal device according to claim 10,
the incident side polarizing plate further including a fourth protection layer disposed on a side of the second polarizing film opposite the liquid crystal layer, and
the fourth protection layer including a fifth optical axis, the fourth protection layer being disposed such that the fifth optical axis is aligned with the transmission axis of the second polarizing film.

12. The liquid crystal device according to claim 7, further comprising:
a second support substrate having a sixth optical axis, the second support substrate being bonded to a side of the fourth protection layer opposite the second polarizing film side such that the sixth optical axis is aligned with the transmission axis, the fourth optical axis, and the fifth optical axis.

13. The liquid crystal device according to claim 12,
the second support substrate being made of sapphire or crystal.

14. The liquid crystal device according to claim 6, the crystal layer including liquid crystal molecules having negative dielectric anisotropy, and
the incident side and emitting side polarizing plates being disposed to have transmission axes orthogonal to each other.

15. On electronic apparatus comprising:
a housing; and
the liquid crystal device of claim 6 within the housing.

16. A method of forming a polarizing plate, the method comprising:
forming a polarizing film having a transmission axis; and
forming a first protection layer having a predetermined first optical axis by stretching the first protection layer,
the first protection layer being formed so as to be disposed on one side of the polarizing film such that the first optical axis is aligned with the transmission axis of the polarizing film.

17. The method of forming a polarizing plate according to claim 16, the method further comprising:
forming a second protection layer having a second optical axis, the second optical axis being aligned with the transmission axis of the polarizing film,
the polarizing film being disposed between the second protection layer and the first protection layer.

18. A polarizing plate comprising:
a first protection layer with a first optical axis formed by being stretched in a first predetermined direction;
a second protection layer having a second optical axis aligned with the first optical axis, the second optical axis being formed by stretching the second protection layer in a second predetermined direction; and
a polarizing film disposed between the first protection layer and the second protection layer, the polarizing film having a transmission axis aligned with the first optical axis and the second optical axis.

19. The polarizing plate according to claim 1, wherein modulated light incident to the first protection layer transmits through the first projection layer without being modulated by the first protection layer.
